(19) United States
(12) Patent Application Publication
(10) Pub. No.: US 2003/0058824 A1
(43) Pub. Date: Mar. 27, 2003

(54) Location-based call management for geographically-distributed communication systems

(76) Inventors: John Allen Petterson, Elgin, IL (US); Robert A. Biggs, Evanston, IL (US)

Correspondence Address: MOTOROLA, INC., 1303 EAST ALGONQUIN ROAD, IL01/3RD, SCHAUMBURG, IL, 60196

(21) Appl. No.: 09/962,825

(22) Filed: Sep. 25, 2001

(51) Int. Cl. H04Q 7/24; H04B 7/212

(52) U.S. Cl. 370/338; 370/349; 370/444

(57) ABSTRACT

Location-based call management methods for geographically-distributed communication systems, including conventional (FIG. 1) and trunking (FIG. 3) systems operable in full duplex mode. A base station controller (111) of a conventional system receives (202) a message, determines (204) a message priority and sends (210, 214, 220) the message to recipient devices selected from among a console (122), local base station (101) and adjacent base station(s) (102, 103) based on the message priority. A zone controller (308) of a trunking system determines an associated site (301) and one or more adjacent sites (302, 303) for a prospective talkgroup call and, based on availability (406, 416, 428) of resources, assigns (424, 432) site(s) to the call. A mobile communication device (320) determines (506, 510) a selected site and adjacent site(s) and respective talkgroups, affiliates (508) with the selected site talkgroup and enters (512) the adjacent site talkgroup(s) in a scan list. Thereafter, the communication device is able to receive (518) calls for the affiliated or adjacent site talkgroups.

### FIELD OF THE INVENTION

This invention relates generally to communication systems and, more particularly, to location-based call management for geographically-distributed communication systems.

### BACKGROUND OF THE INVENTION

Communication systems typically include a plurality of communication units, such as mobile or portable radio units and dispatch consoles that are geographically distributed across multiple sites. The communication units often roam from site to site and wirelessly communicate with RF base site transceivers (“base stations”) and each other at the various sites. As will be appreciated, there are several examples of geographically-distributed communication systems including railroad, police and public safety communication systems where communication units are eligible to roam to different geographic locations. In the case of a railroad system, mobile or portable radio units in various railroad cars are eligible for travel via a network of railways to several geographic locations served by different base stations. The railroad communication system usually includes dispatch console positions responsible for controlling different sections of track.

Traditionally, railroads throughout the world have operated over a conventional (non-trunked), simplex radio network, where the communication units and base stations all transmit and receive on the same frequency. However, simplex radio networks are considered inefficient because communication occurs in only one direction at a given time. That is, while a particular communication unit is transmitting, other communication units receiving the signal can not respond until the first communication unit has finished transmitting. Moreover, even when the communication unit has finished transmitting, only one communication unit can respond at a time.

To provide more efficient communication, full duplex is a manner of operation whereby communication units can talk and listen at the same time on different frequencies. Full duplex solutions have been developed both for conventional systems (using dedicated frequency pairs at each site) and for trunking systems (allocating communication resources at each site on a call-by-call basis). Heretofore, however, both conventional and trunking call management has been user-based. That is, in a user-based system, a radio communicates with other base sites only if users sharing a common characteristic are affiliated with those sites. User-based systems can accommodate adding sites as users roam into the sites or removing sites as users roam out of the sites, but otherwise does not contemplate communication with any particular sites.

It would be desirable for some applications to provide full duplex conventional and trunking systems that are location-based, rather than user-based. For example, a location-based system could provide communication with particular sites based on their location or proximity to a user's present site. It is envisioned that location-based systems would be particularly advantageous for railroad applications because mobile train crews can move from site to site very rapidly (typically every 10-20 minutes at high speeds) and must be able to hear others at adjacent sites to accelerate their awareness and reaction to emergency situations. A typical duplex solution might not provide adequate coverage for the immediate area surrounding the caller. A location-based system could also be utilized for virtually any geographically distributed communication system where a communication unit may desire to communicate with adjacent or nearby sites.

Accordingly, there is a need for call management systems, devices and/or methods for geographically-distributed communication systems that are location-based, rather than user-based. Advantageously, location-based systems will be provided for both conventional and trunking systems and will support full duplex communication between users or groups including mobile or portable radio units, dispatch consoles and base site transceivers that are distributed across multiple sites. The present invention is directed to satisfying these needs.

### BRIEF DESCRIPTION OF THE DRAWINGS

The foregoing and other advantages of the invention will become apparent upon reading the following detailed description and upon reference to the drawings in which:

FIG. 1 is a block diagram of a location-based conventional communication system according to one embodiment of the invention;

FIG. 2 is a flowchart of a method of call management for a location-based conventional communication system according to the invention;

FIG. 3 is a block diagram of a location-based trunking communication system according to one embodiment of the invention;

FIG. 4 is a flowchart of a method of call management for a location-based trunking communication system according to the invention; and

FIG. 5 is a flowchart showing steps performed by a communication unit to receive calls in a location-based trunking communication system according to the invention.

### DESCRIPTION OF PREFERRED EMBODIMENTS

The following describes location-based call management systems, devices and methods for communication systems, including full-duplex conventional and trunking systems that include users or groups distributed across multiple sites.

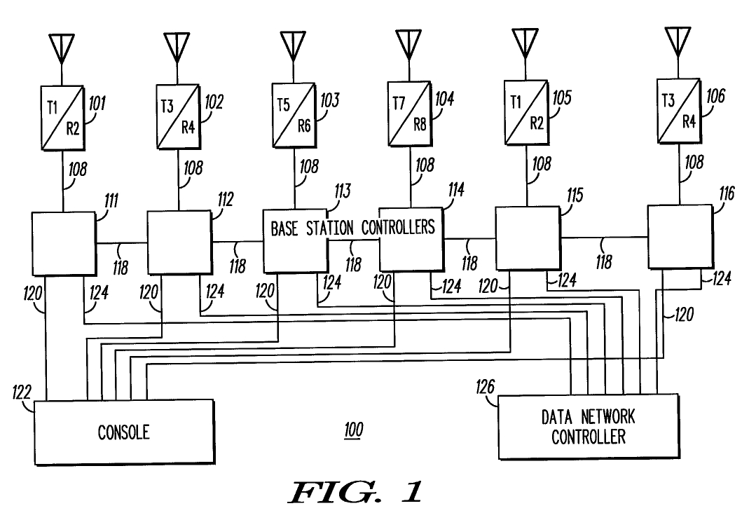

Turning now to the drawings and referring initially to FIG. 1, there is shown a conventional communication system 100 that includes a plurality of RF base site transceivers (“base stations”) 101-106 geographically distributed among various sites. The base stations 101-106 use dedicated communication resources (e.g., frequency pairs T1/R2, T3/R4, T5/R6) to communicate with communication units (not shown) that are distributed among the respective coverage areas of the base stations 101-106. The communication units (sometimes called “subscriber units”) may comprise mobile or portable radio units, cellular telephony devices, or generally any wireless communication device that is eligible to be moved from site to site. The communication units use complementary frequency pairs (e.g., T2/R1, T4/R3, T6/R5) to enable full duplex communication with the base stations.

For convenience, the base stations 101-106 are arranged in linear fashion as they may be encountered by communication units in a railroad application. Thus, for example, communication units would encounter the coverage areas of base stations 101-106 in sequence if traveling left to right, or in reverse sequence if traveling from right to left along a length of railroad track. Of course, it will be appreciated that the communication system 100 is not limited to railroad applications, the base stations may be arranged in virtually any manner and may be encountered in different sequence depending on the manner of travel of the communication units.

In a preferred embodiment, communication units roaming from site to site automatically switch channels to a site with an acceptable signal strength as a presently affiliated site fades to an unacceptable signal strength. Thus, for example, a communication unit traveling from base site 101 to base site 102, initially receiving transmissions from base site 101 on frequency R1 will automatically switch over to frequency R3 to begin receiving transmissions from base site 102 as the signal strength from base site 101 fades to an unacceptable level. In a railroad application, the automatic frequency change removes the need for train crews to constantly change channels as they move from site to site, and the associated risk of becoming out of touch with controllers and other trains. However, railroad users may still need to change frequencies as they enter sections of track controlled by different dispatch consoles in generally the same manner as they do today.

The base stations 101-106 are connected, via links 108, to respective base station controllers 111-116. The links 108 carry payload (e.g., audio, video or data information) or control messages in either direction between the base stations 101-106 and the base station controllers 111-116. For example, the base stations 101-106 may receive, via link 108, outbound payload and/or control messages that are to be transmitted to wireless communication units in their coverage areas or, conversely, the base station controllers 111-116 may receive inbound payload and/or control messages from the base stations 101-106 that were received from wireless communication units.

The base station controllers 111-116 are connected to each other via adjacent station links 118. The adjacent station links 118 enable payload and/or control signaling information to be communicated between adjacent base station controllers (and hence between adjacent base stations). Thus, train crews will be able to hear transmissions from adjacent sites or trains regardless of their currently selected frequencies. The term “adjacent” or “adjacency” as used herein, refers not only to immediately adjacent elements (e.g., base stations 101, 102 or controllers 111, 112) but rather to element(s) in a rolling “window” of proximity to a reference point from which it is desired to hear other transmissions. As will be appreciated, the window of proximity may vary for different applications. For example, in a railroad application where train crews move rapidly from site to site, it may be desired for base stations or controllers to hear transmissions from other sites or trains within plus or minus ten miles. This may result in multiple adjacent elements depending, of course, on the distance between elements.

The base station controllers 111-116 are further connected to a console 122 (e.g., dispatch console) via links 120 and to a data network controller 126 via links 124. The links 120 are adapted to carry payload or control signaling information between the console 122 and the base station controllers 111-116 and the links 124 are adapted to carry data and mobility information between the data network controller 126 and the base station controllers 111-116.

The base station controllers thus have four possible sources of information: transmissions from wireless communication units received by local base station links 108, transmissions from the console 122 via wireline link 120, one or more adjacent station links 118 and a data network connection via link 124. Base station controllers also have four destinations to send information: outbound transmissions to wireless communication units via the local base stations, transmissions to the console 122 via the wireline link 120, one or more adjacent station links 118 and the data network connection via link 124.

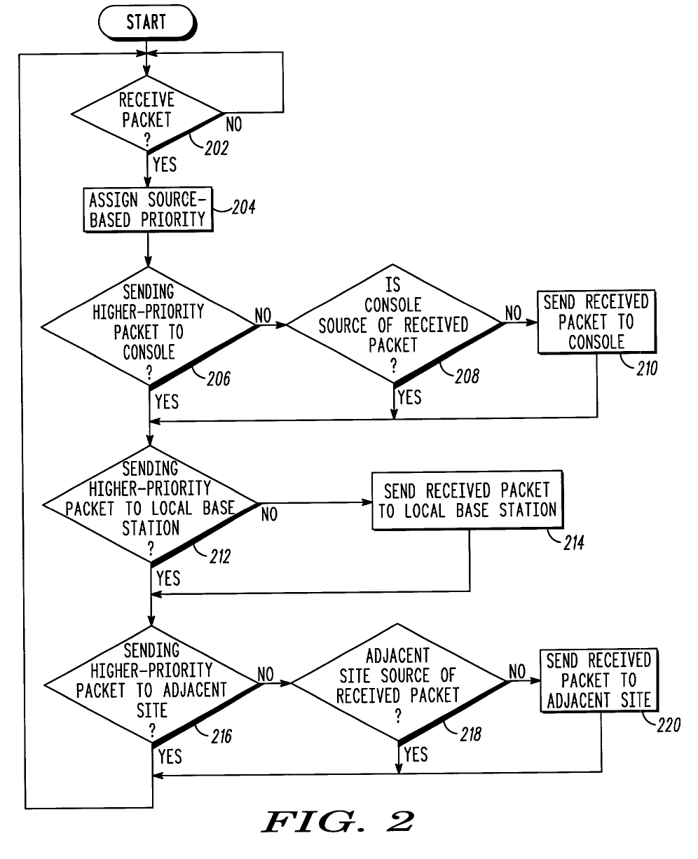

FIG. 2 is a flowchart illustrating steps performed by a base station controller for routing inbound messages over selected sites in a location-based conventional system. Advantageously, the conventional system provides group dispatch communication capability for communication devices including consoles, local base stations and adjacent base stations and any wireless communication devices in the coverage areas of the local and adjacent base stations. The local and adjacent base stations are determined as described above, according to a window of proximity to a particular base station controller of reference. For example, with reference to base station controller 111, the local base station is base station 101 and base stations 102, 103 may define the adjacent base stations. The base station controller 111 is linked to the consoles, local and adjacent stations by one or more communication paths (e.g., links 108, 118, 120).

At step 202, a base station controller receives an inbound message comprising one or more packets (e.g., payload or control packets) from a sourcing communication device. For example, with reference to FIG. 1, base station controller 111 may receive inbound voice packets from its local base site 101 via link 108, from adjacent base sites 102, 103 via link(s) 118, from the console 122 via link 120 or from the data network controller via link 124.

At step 204, the base station controller determines a source-based message priority, that is a priority to the packets received at step 202 based on the source of the packets. In one embodiment, the source-based priority is statically configured as priority 1 (highest priority) for packets received from the dispatch console via link 120; priority 2 for packets received from the associated base site (or “local base site”) via link 108; priority 3 for packets received from an adjacent base site via link 118; and priority 4 (lowest priority) for data packets received from the data controller 126. As will be appreciated, source-based priorities may be assigned differently, or changed from time to time as needed or desired for different applications or situations.

The remaining steps of FIG. 2 are used by the base station controller to determine where it will send the received message packets, for example, via link 120 to the console 122, via link 108 to the local base station 101 and/or via link(s) 118 to the adjacent base stations 102, 103. Generally, the packets are sent to recipient devices unless they are presently being sent a higher priority message.

At step 206, the base station controller determines whether it is already sending higher-priority packet(s) to the console 122. If not, the base station controller determines at step 208 if the console 122 is the source of the packet(s) received at step 202. If the base station controller is not already sending higher priority packets to the console and the console is not the source of the presently received packet(s), the base station controller sends the presently received packet(s) to the console at step 210. Otherwise, if the base station controller is either already sending higher priority packets to the console or the console is the source of the presently received packet(s), the base station controller does not send the presently received packet(s) to the console, but rather proceeds to step 212.

At step 212, the base station controller determines whether it is already sending higher-priority packet(s) to its local base station. If not, the base station controller sends the presently received packet(s) to the local base station at step 214. It is noted, the base station controller will send packets to the local base station at step 214 even if the local base station is the source of the received packets. If the base station controller is already sending higher priority packets to the local base station, the base station controller does not send the presently received packet(s) to the local base station, but rather proceeds to step 216.

At step 216, the base station controller determines whether it is already sending higher-priority packet(s) to an adjacent site or sites. If not, the base station controller determines at step 218 if the adjacent site(s) are the source of the packet(s) received at step 202. If the base station controller is not already sending higher priority packets to the adjacent site(s) and the adjacent site(s) are not the source of the presently received packet(s), the base station controller sends the presently received packet(s) to the adjacent site(s) at step 220. Otherwise, if the base station controller is either already sending higher priority packets to the adjacent site(s) or the adjacent site(s) are the source of the presently received packet(s), the base station controller does not send the presently received packet(s) to the adjacent site(s) and the process returns to step 202.

In the embodiment where source-based priorities are defined, highest to lowest, as dispatch console, local base site, adjacent base site(s) and data packets, the flowchart of FIG. 2 may be summarized as follows. In most instances, when dispatch console packets are received at a base station controller, the packets are sent to the local base station and to the adjacent base stations to be transmitted over the RF to wireless units. An exception occurs if higher-priority console packets are being sent to the local and/or adjacent base stations. In the case of inbound message transmissions received from a local base station, in most instances the packets are repeated at the local base station, sent to the console and sent to the adjacent base stations. An exception occurs if console packets or higher-priority inbound messages are being sent to the local base station, console or adjacent base stations. Finally, in the case of packets being received from an adjacent site, the packets are repeated at the local base station and sent to the console. An exception occurs if console packets, inbound messages from the local base station or higher-priority messages from adjacent sites are being sent to the local base station or console.

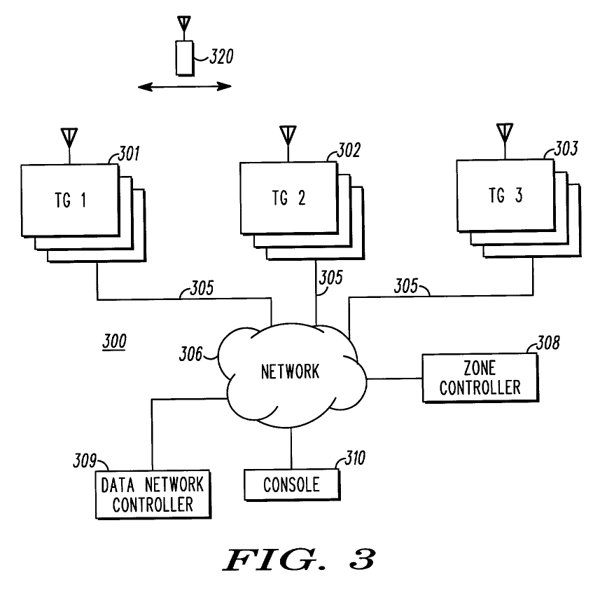

Now turning to FIG. 3, there is shown a trunking communication system 300 that includes a first, second and third base site 301, 302, 303 each having plurality of RF base site transceivers (“base stations”). Similar to FIG. 1, the base sites 301-303 are shown in a linear arrangement as they may be encountered by communication units in a railroad application. However, it will be appreciated that the communication system 300 is not limited to railroad applications, the base sites may be arranged in virtually any manner and may be encountered in different sequence depending on the manner of travel of the communication units.

The base stations at the base sites 301-303 use wireless communication resources to communicate with wireless communication units distributed within their respective coverage areas. For convenience, only a single wireless communication unit 320 is shown. The wireless communication unit(s) may comprise mobile or portable radio units, cellular telephony devices, or generally any wireless communication device. The wireless communication resources may comprise virtually any radio frequency (RF) channel type, including but not limited to narrow band frequency modulated channels, time division modulated slots, carrier frequencies and frequency pairs, which may be accessed by Frequency Division Multiple Access (FDMA), Time Division Multiple Access (FDMA), Code Division Multiple Access (CDMA) or generally any means of channel access. As will be appreciated, while three base stations are shown at three base sites 301-303, the present invention may be implemented with fewer or greater numbers of base stations at each site, or with fewer or greater sites.

Typically, one of the base stations at each site is designated as a control channel transceiver, while the remaining base stations are designated as payload channel transceivers. The control channel transceiver is used for communicating control information and the payload channel transceivers are used for communicating payload information to and from the communication units at each site. In one embodiment, the payload channels are dedicated for use by different talkgroups at each site. As shown, for example, the payload channels at site 301 are dedicated for talkgroup 1, the payload channels at site 302 are dedicated for talkgroup 2 and the payload channels at site 303 are dedicated for talkgroup 3.

The base sites 301-303 are connected via links 305 to a network 306. In one embodiment, the network 306 comprises a packet switched network having a series of routers (not shown) for transporting data, including but not limited to Internet Protocol (IP) datagrams representative of payload or control messages in either direction between the base sites and other endpoints of the communication system 300. As shown, the endpoints include a communication resource controller (“zone controller”) 308, a data network controller 309 and a dispatch console 310.

The zone controller 308 controls the allocation of the communication resources for talkgroup calls between communication devices including wireless communication units distributed among the base sites 301-303, the data network controller 309 and dispatch console 310. As will be appreciated, the zone controller is a functional element that may reside within either of the base sites 301-303, at a fixed equipment (“infrastructure”) site remote from the base sites 301-303, or may be distributed among multiple base sites and/or infrastructure sites.

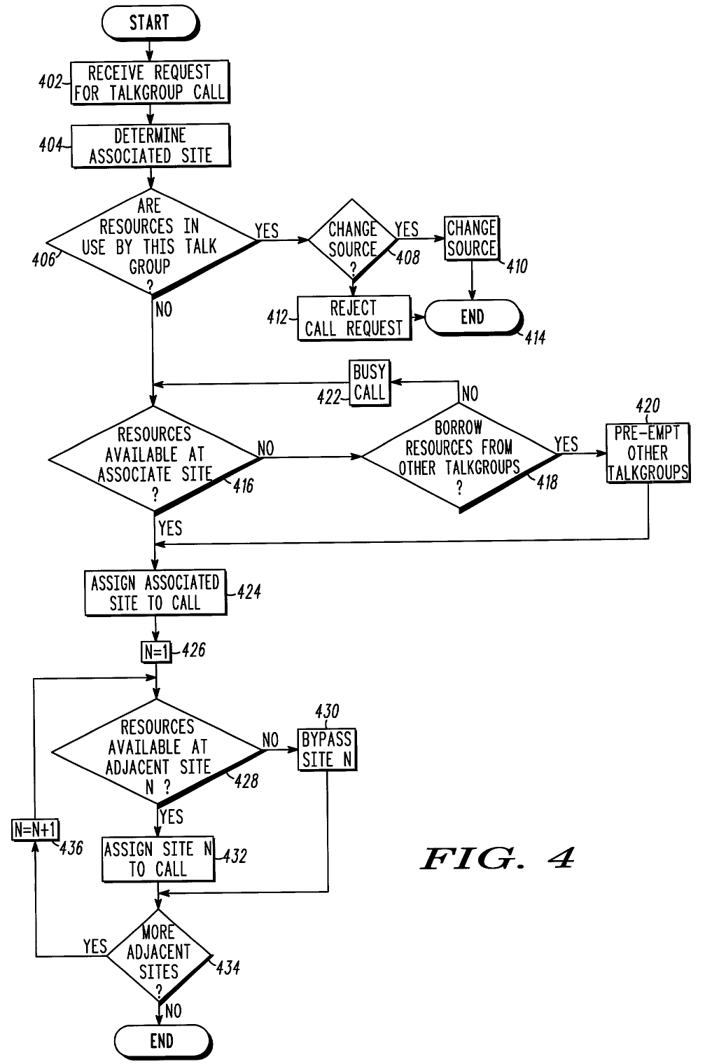

FIG. 4 is a flowchart illustrating a method of call management performed by the zone controller 308. At step 402, the zone controller receives a request for a prospective talkgroup call. Suppose, for example, the request is received from a member (“first member”) of talkgroup 1. At step 404, the zone controller determines an associated site for the talkgroup call. Generally, associated site(s) are those sites having users affiliated with the requested talkgroup. In the present example, the single site 301 is the associated site for talkgroup 1. Alternatively, if users affiliated with the talkgroup were at multiple sites, the zone controller could select one or more of those sites as associated sites.

At step 406, the zone controller determines whether resources are in use by the requested talkgroup (e.g., talkgroup 1) at the associated site. If so, that means that there is already an active talkgroup call currently being sourced by another member (“second member”) of the talkgroup that the first member requested at step 402. In such case, the zone controller determines at step 408 whether it desires to change sources of the active talkgroup call (e.g., from the second member to the first member). The zone controller may wish to change sources, for example, if the first member is a higher priority source than the second member. In one embodiment, priority 1 (highest priority) is assigned to dispatch console 310 , priority 2 is assigned to wireless users affiliated with the associated site and priority 3 (lowest priority) for the data controller 309. If at step 408 the zone controller determines to change sources, it does so at step 410. As will be appreciated, the step of changing sources comprises making resources available to the first member that were previously being used by the second member. If at step 408 the zone controller determines not to change sources, it rejects the call request of the first member at step 412 and the process ends at step 414.

If at step 406, the zone controller has determined that resources are not already in use by the requested talkgroup, the zone controller determines at step 416 whether resources are available at the associated site. If resources are available, the zone controller assigns at step 424 the associated site to the call. That is, the zone controller causes the resources at the associated site to be used for the call. If resources are determined at step 416 as not available, the zone controller determines at step 418 whether it desires to “borrow” resources from other talkgroups that may be active. The zone controller may wish to borrow resources, for example, if the requested talkgroup (e.g., talkgroup 1) is higher priority than the presently active talkgroup(s). If at step 418 the zone controller determines to borrow resources from other talkgroup(s), it pre-empts the presently active talkgroups at step 420 to make resources available for the requested talkgroup. If at step 418 the zone controller determines not to borrow resources from other talkgroup(s), it busies the call request of the first member at step 422 until such time as resources are determined to be available at step 416.

After having assigned the associated site to the call at step 424, the remaining steps of the flowchart are used to determine whether to assign (or bypass) adjacent sites to the call. For convenience, the flowchart uses the variable “N” to designate which one of the adjacent sites that is presently being considered. The variable N is initially set to 1 at step 426 to indicate that adjacent site “1” is the first to be considered. The variable N is incremented by 1 at step 436 each time a next consecutive adjacent site is to be considered. The adjacent sites are defined in substantially the same manner described in relation to FIG. 1. That is, the adjacent sites include site(s) in a rolling window of proximity to a particular reference. The window of proximity may comprise, for example, any sites within plus or minus ten miles from the associated site.

For each of the adjacent sites N, the zone controller determines at step 428 whether resources are available to support the talkgroup call. If resources are available at any of the adjacent sites, the zone controller assigns the adjacent site(s) to the call at step 432. Adjacent sites not having resources available to support the call are bypassed at step 430. That is, adjacent sites not having resources are not assigned to the call. The process ends after all adjacent sites have been considered and either assigned to the call at step 432 or bypassed at step 430.

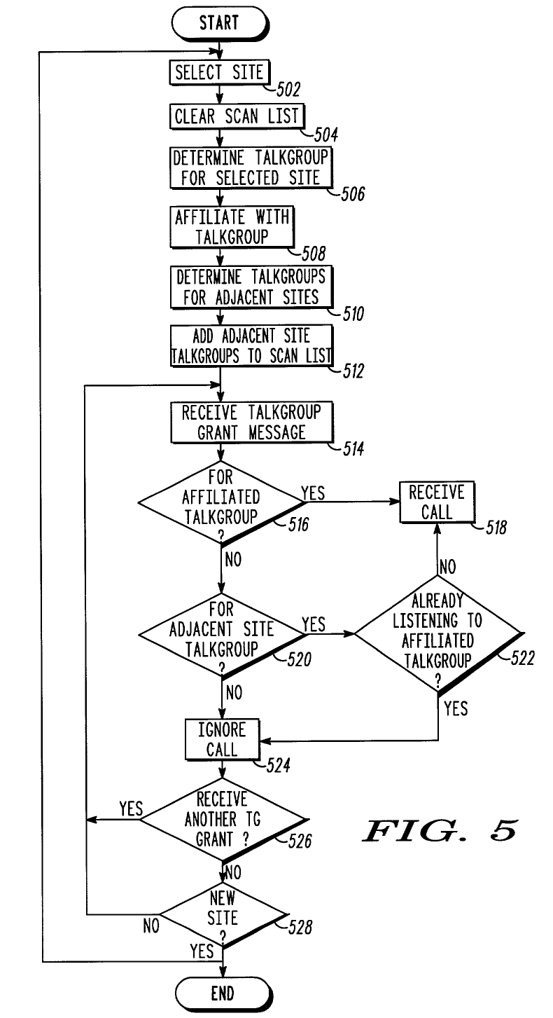

FIG. 5 is a flowchart showing steps performed by a wireless communication unit to receive calls in a trunking communication system of the type shown at FIG. 3. At step 502, the communication unit selects a site that it desires to monitor. In a preferred embodiment, the selection of sites is accomplished automatically based on received signal strength as the communication unit travels from site to site in generally the same manner as has been described in relation to FIG. 1. Thus, for example, with reference to FIG. 3, a communication unit traveling from base site 301 to base site 302 will automatically select site 302 (thereby deselecting site 301) as the signal strength from site 301 fades to an unacceptable level. This is a known capability within data systems and trunking voice systems.

At step 504, the communication unit clears a scan list stored in memory of the communication unit, which scan list is adapted to store indicia of one or more adjacent site talkgroups. Thus, clearing the scan list erases any previous indicia of adjacent site talkgroups.

At step 506, the communication unit determines a talkgroup for the selected site. In one embodiment, this is accomplished by referencing a look-up table stored in memory of the communication unit. For example, with reference to FIG. 3, talkgroup 1 is the talkgroup for site 301, talkgroup 2 is the talkgroup for site 302 and talkgroup 3 is the talkgroup for site 303. At step 508, the communication unit “affiliates” or registers affiliation with the talkgroup by sending a message to the zone controller. The talkgroup thereby defines an affiliated talkgroup.

At step 510, the communication unit determines the talkgroup(s) for one or more adjacent sites. The adjacent sites and talkgroups may be determined by referencing a look-up table stored in memory of the communication unit. After having determined the talkgroup(s) for the adjacent site(s), the communication unit at step 512 adds the adjacent site talkgroups to its scan list. The scan list will contain a new list of adjacent site talkgroups each time the communication unit roams to and selects a new site.

At step 514, the communication unit receives a talkgroup grant message indicative of a talkgroup call. The communication unit determines at step 516 if the talkgroup grant message is for the affiliated talkgroup and at step 520 if the talkgroup grant message is for an adjacent site talkgroup. If at step 516, the talkgroup grant message is for the affiliated talkgroup, the communication unit receives the call at step 518. If at step 520, the talkgroup grant message is for an adjacent site talkgroup, the communication unit first receives the call at step 518 only if it is not already listening to the affiliated talkgroup (determined at step 522). In a preferred embodiment, the step of receiving the call at step 518 is accomplished by automatically selecting the appropriate RF channel and/or time slot, typically identified in the call grant message. Alternatively, in a system where the communication unit is an Internet Protocol (IP) host device, the step of receiving the call may comprise joining a multicast P address identified in the call grant message. If, at step 522, the communication unit is already listening to the affiliated talkgroup, it ignores the call at step 524. The communication unit also ignores the call at step 524 if the call grant message is neither for the affiliated talkgroup or an adjacent site talkgroup. If the communication unit receives another talkgroup grant, the process returns to step 514. If the communication unit moves to a new site, the process returns to step 502.

The present disclosure therefore has identified location-based call management systems, devices and methods for geographically-distributed communication systems, including conventional and trunking systems. The systems will support full duplex communication between users or groups including mobile or portable radio units, dispatch consoles and base site transceivers that are distributed across multiple sites.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a communication system providing group dispatch communication capability for a plurality of communication devices linked to a controller by one or more communication paths, a method comprising the controller performing steps of:
receiving, from a sourcing communication device of the plurality of communication devices, a message comprising one or more packets;
determining, based on a priority of the sourcing communication device, a message priority;
sending the message, via one or more of the communication paths, to a number of recipient communication devices of the plurality of communication devices, if the recipient communication devices are not already being sent a higher priority message.

2. The method of claim 1, wherein the recipient communication devices include at least one console, the step of sending a message comprising:
sending the message to the at least one console if it is not already being sent a higher priority message and if it is not the sourcing communication device.

3. The method of claim 1, wherein the recipient communication devices include a local base station, the step of sending a message comprising:
sending the message to the local base station if it is not already being sent a higher priority message.

4. The method of claim 3, wherein the recipient communication devices further include at least one adjacent base station, the step of sending a message comprising:
sending the message to the at least one adjacent base station if it is not already being sent a higher priority message and if it is not the sourcing communication device.

5. The method of claim 1, wherein the one or more packets comprise audio packets.

6. The method of claim 1, wherein the one or more packets comprise data packets.

7. The method of claim 1, wherein the one or more packets comprise control signaling packets.

8. The method of claim 1, wherein the controller comprises a base station controller of a non-trunked communication system.

9. In a communication system including a plurality of base sites having geographically distributed coverage areas, the base sites providing group dispatch communication capability for communication devices distributed among the coverage areas, a method comprising:
receiving, from a first member of a first talkgroup, a request for a prospective talkgroup call;
identifying a site of the plurality of base sites associated with the prospective talkgroup call, defining an associated site;
determining an availability of resources at the associated site;
in response to a positive determination of availability at the associated site,
assigning the associated site to support the call;
identifying one or more sites of the plurality of base sites in a window of proximity to the associated site, defining adjacent sites;
determining an availability of resources at the adjacent sites; and
in response to a positive determination of availability at one or more of the adjacent sites, assigning the one or more adjacent sites to support the call.

10. The method of claim 9, wherein the step of determining an availability of resources at the associated site comprises:
determining that resources at the associated site are being used for an active talkgroup call of the first talkgroup, sourced by a second member of the first talkgroup;
determining priorities of the first member and second member;
if the first member is higher priority than the second member, assigning the first member to replace the second member as source of the active talkgroup call, and making a positive determination of availability.

11. The method of claim 10, comprising,
if the first member is lower priority than the second member, making a negative determination of availability; and rejecting the request for a prospective talkgroup call.

12. The method of claim 9, wherein the step of determining an availability of resources at the associated site comprises:
determining that resources at the associated site are being used for an active talkgroup call of a second talkgroup;
determining priorities of the first talkgroup and second talkgroup;
if the first talkgroup is higher priority than the second talkgroup, pre-empting the active call of the second talkgroup, thereby causing resources to become available for the first talkgroup; and making a positive determination of availability.

13. The method of claim 12, comprising,
if the first talkgroup is lower priority than the second talkgroup, making a negative determination of availability; and busying the request until such time as resources become available for the prospective call.

14. In a communication system including a plurality of base sites having geographically distributed coverage areas, a method comprising a communication device eligible for movement between the coverage areas performing steps of:
selecting a local site of the plurality of base sites, thereby defining a selected site;
identifying a talkgroup associated with the selected site;
registering affiliation with the talkgroup, the talkgroup thereby defining an affiliated talkgroup;
identifying one or more sites of the plurality of base sites in a window of proximity to the selected site, defining one or more adjacent sites;
identifying, for each of the one or more adjacent sites, an associated talkgroup, thereby defining one or more adjacent site talkgroups;
upon receiving a call grant message indicative of a talkgroup call for the affiliated talkgroup, selecting a communication resource that enables the communication device to receive the call; and
upon receiving a call grant message indicative of a talkgroup call for an adjacent site talkgroup, selecting a communication resource that enables the communication device to receive the call unless the communication device is presently receiving a call for the affiliated talkgroup.

15. The method of claim 14, wherein the step of selecting a communication resource comprises selecting at least one of: a radio channel and timeslot identified in the call grant message.

16. The method of claim 14, wherein the step of selecting a communication resource comprises joining a multicast group address identified in the call grant message.

17. The method of claim 14, wherein, in response to defining one or more adjacent site talkgroups, the communication device stores indicia of the adjacent site talkgroups in a scan list, the communication device being operable, in a scan mode, to access the one or more of the adjacent site talkgroups identified in the scan list.

18. The method of claim 17, wherein, before storing indicia of the adjacent site talkgroups in a scan list, the communication device clears the scan list of any previous indicia of adjacent site talkgroups.
